(19) United States
(12) Patent Application Publication
(10) Pub. No.: US 2004/0133983 A1
(43) Pub. Date: Jul. 15, 2004

(54) Surgical table

(76) Inventors: David C. Newkirk, Lawrenceburg, IN (US); Richard L. Borders, Erie, CO (US); Richard H. Heimbrock, Cincinnati, OH (US)

Correspondence Address: BARNES & THORNBURG, 11 SOUTH MERIDIAN, INDIANAPOLIS, IN, 46204

(21) Appl. No.: 10/340,948

(22) Filed: Jan. 13, 2003

(51) Int. Cl. A61G 7/015; A61G 7/05

(52) U.S. Cl. 5/624; 5/600; 5/618

(57) ABSTRACT

A patient-support apparatus, such as a surgical table, includes a longitudinally-extending base supported on a floor and a longitudinally-extending deck supported above the base by first and second lift assemblies. The deck is articulatable to support a patient in selected positions. The lift assemblies are extendible in a vertical direction. The base is extendible in the longitudinal direction.

### BACKGROUND AND SUMMARY OF THE INVENTION

The present disclosure relates to surgical tables, and particularly to orthopedic surgical tables. More particularly, the present disclosure relates to a surgical table that is configurable for various types of orthopedic surgery.

Orthopedic surgery is surgery performed on a patient's bones and related nerves and connective tissue. Examples of common orthopedic surgeries include joint replacement, joint reconstruction, and fracture repair. Orthopedic surgeries dealing with a patient's legs, shoulders, or spine are quite common. Some known surgical tables are usable for multiple types of surgeries, including orthopedic surgery.

According to this disclosure, a patient-support apparatus, such as a surgical table, includes a longitudinally-extending base supported on a floor and a longitudinally-extending deck supported above the base by first and second lift assemblies. The deck is articulatable to support a patient in selected positions. The lift assemblies are extendible in a vertical direction. The base is extendible in the longitudinal direction.

In illustrative embodiments, the articulating deck comprises back, seat and foot sections. The back, seat and foot sections are longitudinally spaced apart with the back and foot sections articulatable relative to the seat section. The seat section includes a central portion and first and second countertraction side portions on the opposite sides of the central portion near the foot section. The first and second countertraction side portions are removably coupled to the central portion of the seat section. A countertraction post is detachably coupled to the seat section.

Illustratively, the countertraction side portions are detached from the central portion of the seat section and the countertraction post is attached to the seat section for applying bilateral or unilateral hip traction to a patient supported on the deck, or for performing a lateral intramedullary nailing procedure on the patient. On the other hand, the countertraction post is detached from the seat section and the countertraction side portions are reattached to the central portion for general surgical procedures.

According to another aspect of this disclosure, the deck includes a guide rail. A mount is coupled to the guide rail, and is movable longitudinally along the guide rail. A traction bar is movably coupled to the mount for lateral movement. A traction boot assembly is configured to be coupled to the traction bar, and is movable along a longitudinal dimension of the traction bar for applying traction to a patient supported on the deck.

In illustrative embodiments, the guide rail extends generally longitudinally and centrally relative to the deck. The traction boot assembly includes an elongated rod that is translatably received in a longitudinally-extending passageway in the traction bar, a traction boot configured to couple to a patient's foot, and an adjustment assembly coupled to the traction boot and coupled to the elongated rod. The adjustment assembly is configured to permit rotational and translational adjustment of the traction boot relative to the elongated rod.

In other illustrative embodiments, the adjustment assembly comprises a housing to which the traction boot couples and a joint that couples the housing to the elongated rod. A tube extends from the housing, and a post extends from the traction boot. The tube includes a first opening that receives the post when the traction boot is coupled to the tube in a first orientation for storage. The tube includes a second opening that receives the post when the traction boot is coupled to the tube in a second orientation for applying traction to a patient's foot. In some illustrative embodiments, a hand crank is coupled to the housing and coupled to the tube to translate the traction boot relative to the elongated rod. In other illustrative embodiments, the adjustment assembly includes a manual adjuster that tightens to lock the joint to prevent rotation of the housing and the traction boot relative to the elongated rod, and that loosens to unlock the joint to allow rotation of the housing and the traction boot relative to the elongated rod.

Also according to this disclosure, a patient-support apparatus comprises a longitudinally-extending deck including a head section, a seat section and a foot section with the head, seat and foot sections being longitudinally spaced apart and articulatable. The foot section includes a first portion near the seat section and a second portion away from the seat section near the foot end. The first portion has a first transverse width, and the second portion has a second transverse width that is smaller than the first transverse width such that a pair of cut-out areas are defined alongside the opposite sides of the second portion. A pad is received in each cut-out area of the foot section for movement between a first position where the pad is coplanar with the foot section and a second position away from the first position. Illustratively, the foot section supports a patient's upper body during shoulder surgery with the pads serving as the shoulder pads. At least one shoulder pad is moved to the second position away from its coplanar position to expose a posterior portion of the patient's shoulder.

Additional features will become apparent to those skilled in the art upon consideration of the following detailed description of illustrative embodiments exemplifying the best mode of carrying out the orthopedic table apparatus as presently perceived.

### BRIEF DESCRIPTION OF THE DRAWINGS

The detailed description particularly refers to the accompanying figures, in which:

FIG. 1 is a perspective view of an illustrative patient support apparatus, such as a surgical table, showing a longitudinally-extending base supported on a floor and a longitudinally-extending deck supported above the base by first and second lift assemblies, the deck being articulatable to support a patient in selected positions, each lift assembly being extendible in a vertical direction, the base being extendible in the longitudinal direction, the deck including a back section, a seat section, a foot section and a generally longitudinally-extending centrally-located guide rail (obscured view) coupled to foot section and located thereunder, the back section including a head portion and an upper body support portion, the seat section including a central portion and first and second countertraction side portions on the opposite sides of the central portion near the foot section, and the foot section including a central portion and first and second side portions on the opposite sides of the central portion near the foot end,

FIG. 2 is a perspective view, similar to FIG. 1, showing a patient resting on the articulating deck with the back, seat and foot sections of the deck supporting the patient's upper body, seat and legs respectively,

FIG. 3 is a perspective view, similar to FIG. 1, showing the back section, the central portion of the seat section and the longitudinally-extending centrally-located guide rail, and showing the foot section and the countertraction side portions of the seat section detached from the deck, and showing a vertically-extending countertraction post attached to the central portion of the seat section, a mount coupled to the guide rail and movable longitudinally along the guide rail, the mount shown moved to a position near the seat section, a first elongated traction bar coupled to the mount on a first side thereof for movement about a first pivot axis, and a second elongated traction bar coupled to the mount on a second side thereof for movement about a second pivot axis, the traction bars being movable between respective first positions extending alongside the guide rail and respective second positions spaced laterally from the guide rail,

FIG. 4 is a perspective view, similar to FIG. 3, showing the mount moved away from the seat section to a position near the foot end,

FIG. 5 is a partial sectional view showing the mount, the guide rail and the two traction bars, the guide rail being in the form of a square-shaped tube, and the mount having a square-shaped opening for slidably receiving the square-shaped guide rail,

FIG. 6 is a perspective view, similar to FIG. 3, showing first and second traction boot assemblies coupled to the first and second elongated traction bars, showing the traction bars moved to their respective positions alongside the guide rail, and showing the traction boot assemblies moved to their respective storage positions below the deck, each traction boot assembly including an elongated rod that is received for translation in a longitudinally-extending passageway in the respective traction bar, a traction boot configured to couple to a patient's foot, and an adjustment assembly coupled to the traction boot and coupled to the elongated rod, the adjustment assembly comprising a housing to which the traction boot couples and a joint that couples the housing to the elongated rod, a tube extending from the housing, a post extending from the traction boot, the tube including a first opening that receives the post when the traction boot is coupled to the tube in a first orientation for storage, the tube including a second opening that receives the post when the traction boot is coupled to the tube in a second orientation for applying traction to a patient's foot, the adjustment assembly including a hand crank coupled to the housing and coupled to the tube to translate the traction boot relative to the elongated rod,

FIG. 7 is a perspective view, similar to FIG. 6, showing a patient supported on the deck with the vertically-extending countertraction post lying between the patient's legs and engaging the patient's crotch or pelvic region, and showing the traction bars rotated away from the guide rail, and the pair of traction boot assemblies coupled to the respective feet of the patient to apply bilateral hip traction to the patient, each traction boot comprising a first portion configured to engage a bottom of a patient's foot, a second portion coupled to the first portion for movement between a first position engaging a top of the patient's foot and a second position away from the first position, and a strap that engages the first and second portions of the boot to lock the second portion in the first position,

FIG. 8 is a perspective view, similar to FIG. 7, showing a calf support associated with the patient's right leg supporting the patient's right leg in an elevated position, the calf support including a mounting portion coupled to the traction bar, and showing the traction boot assembly associated with the patient's left leg applying unilateral hip traction to the patient,

FIG. 9 is a perspective view, similar to FIGS. 7 and 8, showing the patient resting on his left side for a lateral intramedullary nailing procedure, and showing an alternative embodiment of a laterally-extending countertraction post disposed between the patient's legs and engaging the patient's pelvic region, and showing the traction boot assembly on the left side of the patient coupled to the right foot of the patient, and the traction boot assembly on the right side of the patient coupled to the left foot of the patient,

FIG. 10 is a perspective view of the illustrative surgical table, showing the countertraction post removed from the deck, and showing the foot section of the deck pivoted upwardly relative to the seat section to support a patient in a sitting-up position for shoulder surgery with his head toward the foot end and the feet toward the head end, and further showing a narrow head attachment coupled to the foot section to support the patient's head, the patient's shoulders being supported by the side portions of the foot section,

FIG. 11 is a perspective view, similar to FIG. 10, showing the right side shoulder support portion of the foot section pivoted away from a cut-out formed in the foot section to expose a posterior portion of the patient's right shoulder for shoulder surgery,

FIG. 12 is a side view of the deck, showing the deck raised to a higher elevation parallel to the floor,

FIG. 13 is a side view of the deck, similar to FIG. 12, showing the back section of the deck raised relative to the foot section to support a patient in a reverse Trendelenburg position,

FIG. 14 is a side view of the deck, similar to FIGS. 12 and 13, showing the deck articulated to support a patient in a reclining position,

FIG. 15 is an end view of the deck, showing the deck pivoted about its longitudinal axis,

FIG. 16 is a block diagram showing a control circuit for various drive mechanisms for the base, deck and lift assemblies,

FIG. 17 is a cut-away top view of the back section, showing a generally rectangular frame of the back section, a generally rectangular panel attached to the frame, a cushion supported by the panel, and accessory rails on the opposite sides of the frame,

FIG. 18 is a top view of the seat section, showing a generally v-shaped central portion of the seat section, generally triangular countertraction side portions on the opposite sides of the central portion, a socket for removably receiving a countertraction post, and accessory rails on the opposite sides of the countertraction side portions,

FIG. 19 shows a manual adjuster for removably attaching the countertraction post to the socket, and comprising a knob and a threaded shaft extending axially from the knob,

FIG. 20 is a cut-away top view of the seat section, similar to FIG. 18, showing the frames of the generally v-shaped central portion of the seat section and generally triangular countertraction side portions of the seat section, panels attached to the respective frames and cushions supported by the respective panels,

FIG. 21 is a top view of the foot section, showing a generally T-shaped central portion of the foot section, generally rectangular side portions on the opposite sides of the central portion, and accessory rails on the opposite sides of the central and side portions,

FIG. 22 is a cut-away top view of the foot section, similar to FIG. 21, showing the frames of the generally T-shaped central portion and generally rectangular side portions of the foot section, panels attached to the respective frames and cushions supported by the respective panels,

FIG. 23 is a perspective view of the traction boot assembly, showing the traction boot decoupled from the tube that extends from the housing of the adjustment assembly, and showing the traction boot being oriented in a first orientation having the post of the traction boot aligned vertically with a first opening extending through the top and bottom walls of the tube, and

FIG. 24 is a perspective view, similar to FIG. 23, showing the traction boot still decoupled from the tube of the adjustment assembly, but oriented in a second orientation having the post of the traction boot aligned with a second opening of the tube extending along a long axis thereof.

### DETAILED DESCRIPTION OF THE DRAWINGS

An illustrative patient support apparatus, such as a surgical table 30, includes a head end 32, a foot end 34, a first side 36, a second side 38, a longitudinal axis 40, a transverse axis 42 and a vertical axis 44. The illustrative surgical table 30 includes a longitudinally-extending base 50 supported on a floor 56 and a longitudinally-extending deck 60 supported above the base 50 by a high/low mechanism 70 comprising head end and foot end lift assemblies 72 and 74. The base 50 and the deck 60 have their respective first and second ends 52, 54 and 62, 64 coupled to the first and second lift assemblies 72, 74. The head and foot ends of the table 30 are also sometimes referred to herein as the first and second ends respectively.

As used in this description, the phrase “head end 32” will be used to denote the end of any referred-to object that is positioned to lie nearest the head end 32 of the table 30, and the phrase “foot end 34” will be used to denote the end of any referred-to object that is positioned to lie nearest the foot end 34 of the table 30. Likewise, the phrase “first side 36” will be used to denote the side of any referred-to object that is positioned to lie nearest the first side 36 of the table 30, and the phrase “second side 38” will be used to denote the side of any referred-to object that is positioned to lie nearest the second side 38 of the table 30.

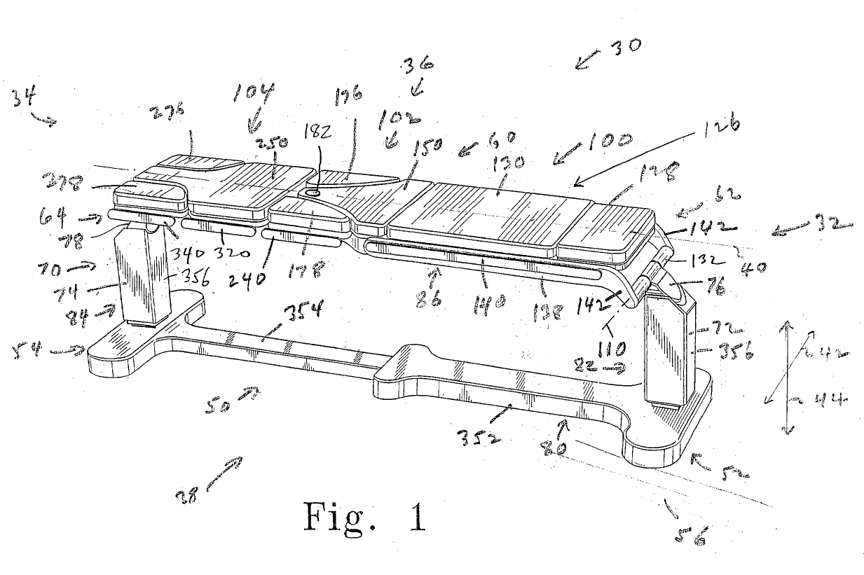

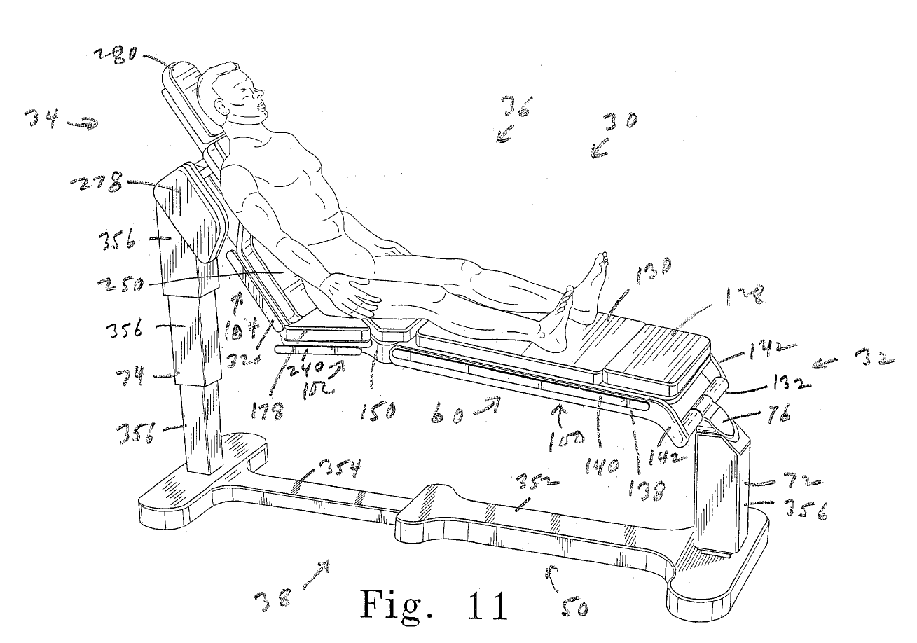

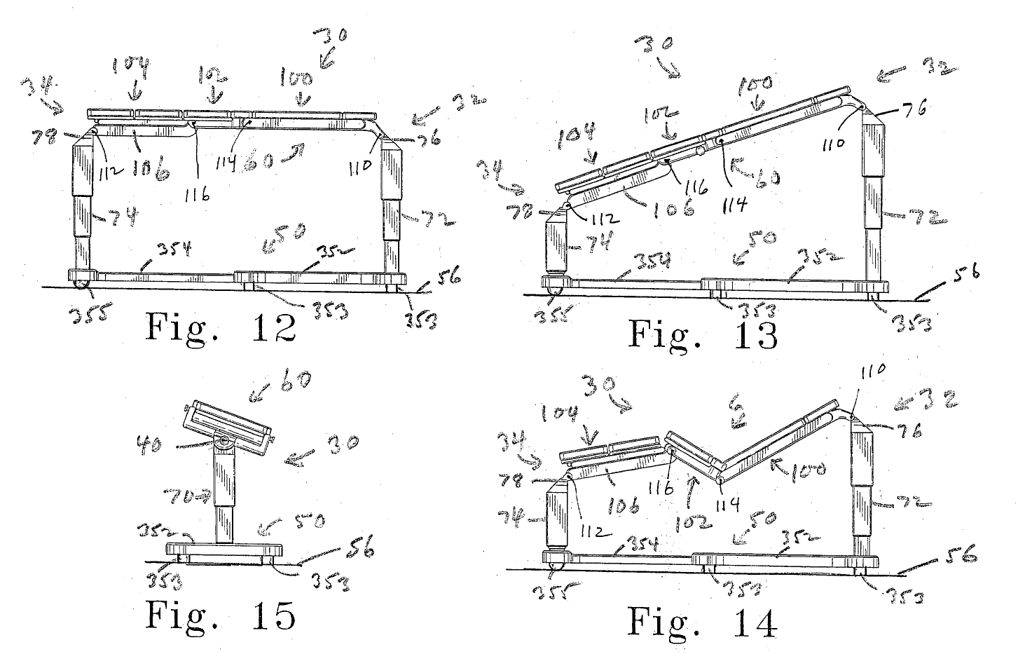

The base 50 includes a first drive mechanism 80 which is operable to extend and retract the base 50 along the longitudinal axis 40. The head end lift assembly 72 includes a second drive mechanism 82 which is operable to raise and lower the head end 32 of the deck 60. The foot end lift assembly 74 includes a third drive mechanism 84 which is operable to raise and lower the foot end 34 of the deck 60. The deck 60 is shown raised in FIG. 12 relative to its position in FIG. 1. The second and third drive mechanisms 82, 84 are also operable to tilt the deck 60 about the transverse axis 42 to a Trendelenburg position (not shown) or to a reverse Trendelenburg position shown in FIG. 13. The articulating deck 60 includes a fourth drive mechanism 86 that is operable to articulate the deck 60 as shown in FIG. 14 to support a patient in selected positions. In addition, the lift assemblies 72, 74 include fifth and sixth drive mechanisms 88, 90 to tilt the deck 60 side-to-side about the longitudinal axis 40 as shown in FIG. 15. A controller 92 is coupled to the drive mechanisms 80-90 as shown in FIG. 16 to synchronize the extension and retraction of the base 50 with the articulation of the deck 60 and the extension and retraction of the two lift assemblies 72, 74. A user input device 94, such as a hand-held pendant or controller, is used to command the operation of the various drive mechanisms 80-90 of the surgical table 30.

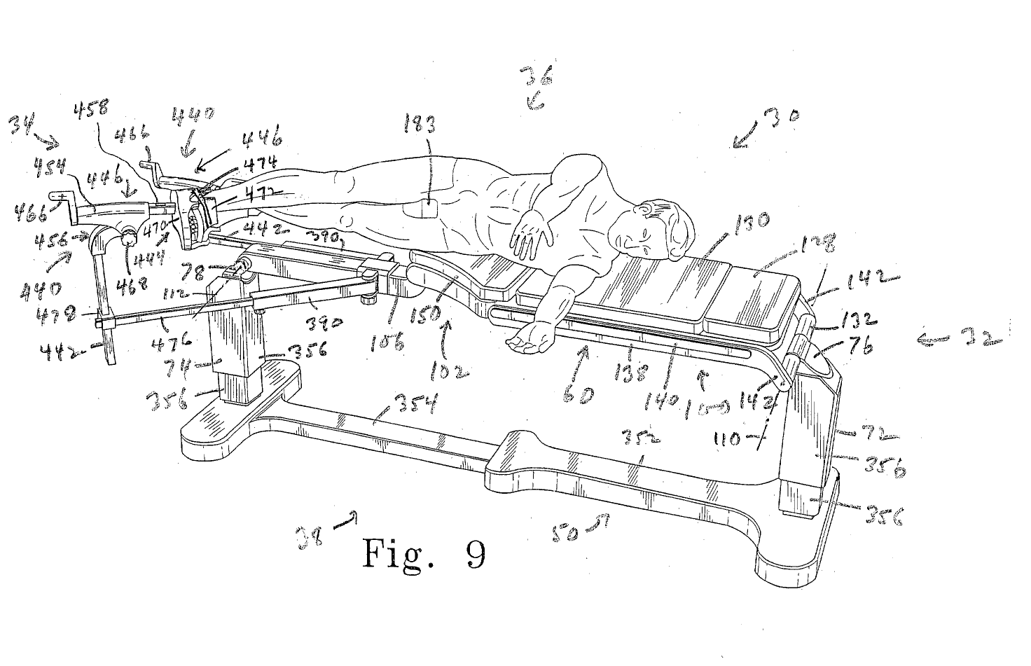

The deck 60 includes a back section 100, a seat section 102, a foot section 104 and a generally longitudinally-extending centrally-located guide rail 106 coupled to foot section 106 and located thereunder. The back, seat and foot sections 100, 102, 104 are longitudinally spaced apart, with the back and foot sections 100, 104 articulatable relative to the seat section 102. The back section 100 is coupled to the first lift assembly 72 for pivotal movement about a first transverse pivot axis 110 near the head end 32 as shown in FIGS. 9 and 12-14. The guide rail 106 carrying the foot section 104 is coupled to the second lift assembly 74 for pivotal movement about a second transverse pivot axis 112 near the foot end 34. The back and foot sections 100, 104 are also sometimes referred to herein as the head and leg sections respectively.

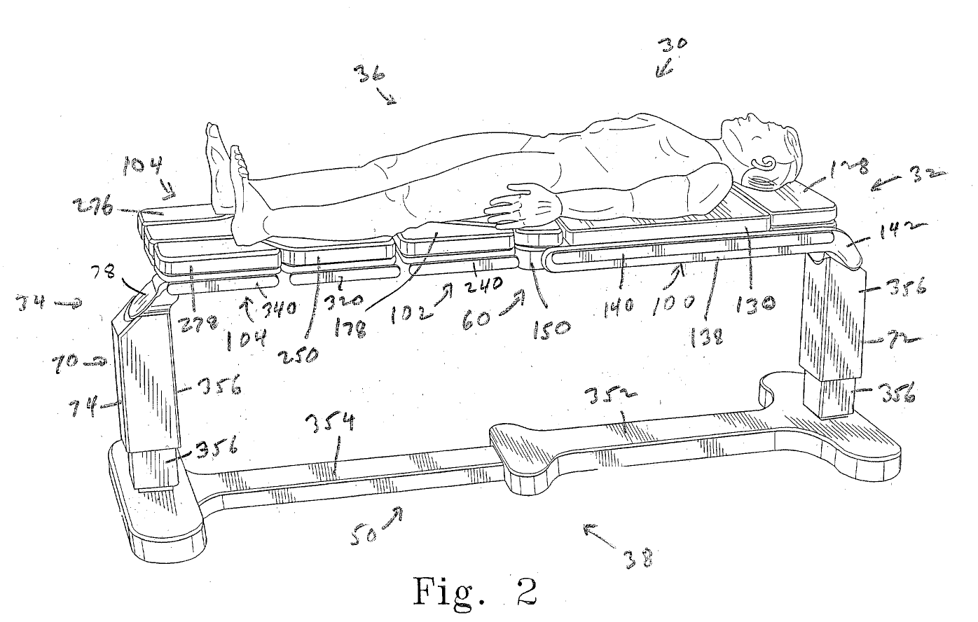

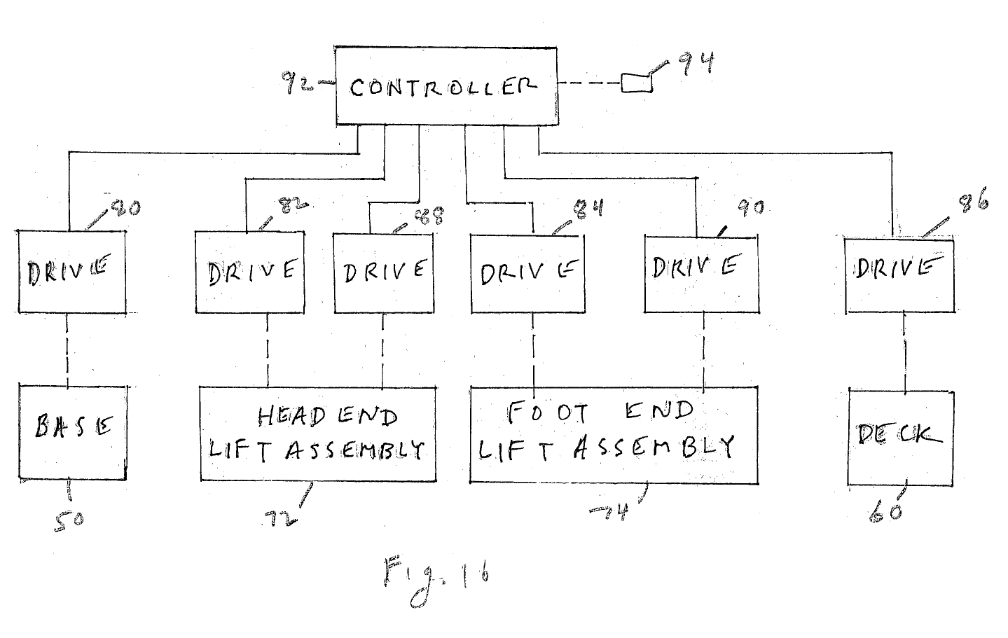

As shown in FIG. 17, the back section 100 includes a generally rectangular frame 122 and a generally rectangular panel 124 attached to the frame 122. The panel 124 includes a substantially planar top surface that supports a cushion 126. As shown in FIGS. 1 and 2, the cushion 126 includes a head portion 128 near the head end 32 to support a patient's head and an upper body portion 130 near the seat section 102 to support a patient's upper body or torso. The frame 122 comprises a foot end cross strut 134 near the seat section 102, first and second laterally-spaced longitudinally-extending side struts 136, 138 that extend forwardly from the foot end cross strut 134 toward the head end 32 and a cross strut 132 near the head end 32. An accessory rail 140 is coupled to each side strut 136, 138 by a pair of spacers that position the accessory rails 140 in spaced-apart relation with the respective side struts 136, 138. In the illustrated embodiment, the foot end cross strut 134, the side struts 136, 138 and the accessory rails 140 each have a generally rectangular cross section. The head end cross strut 132, however, has a circular cross section. The cushion or mattress pad 126 of the generally rectangular back section 100 has the same general shape as the associated panel 124, although, in some embodiments, the cushion or mattress pad 126 overhangs the edges of the associated panel 124 by some amount.

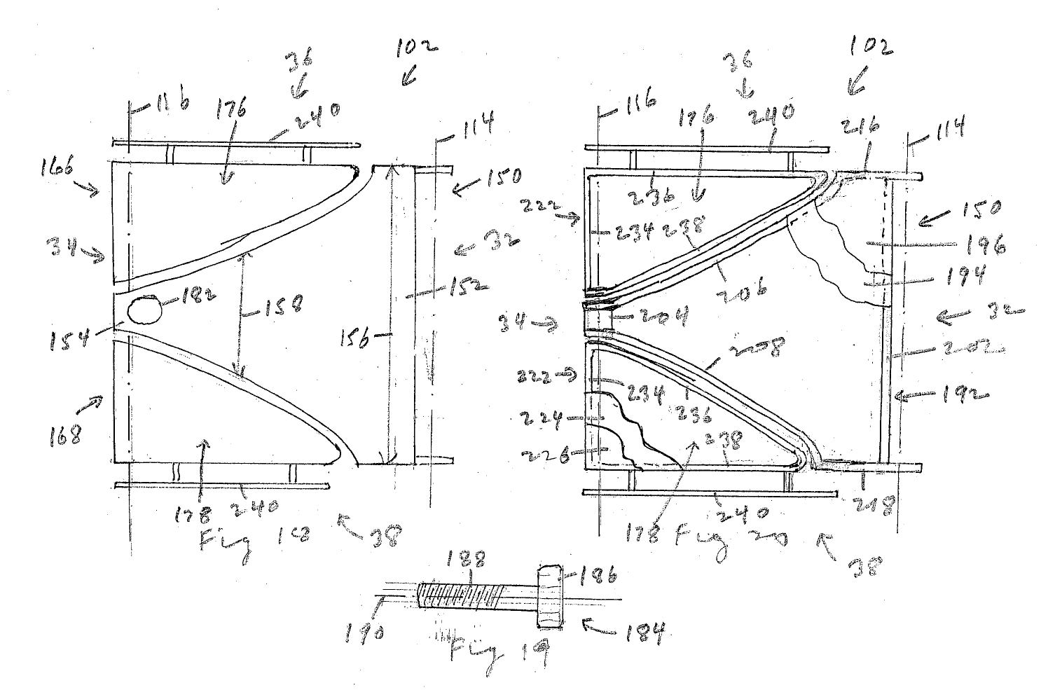

As shown in FIG. 1, the side struts 136, 138 of the back section 100 each include a portion 142 near the head end 32 that extends forwardly and downwardly to support the head end cross strut 132 below the plane of the deck 60. A mounting flange 76 extends upwardly and rearwardly from the head end lift assembly 72, and couples to the head end cross strut 132 of the back section 100 for pivotal movement about the first transverse pivot axis 110 as shown in FIGS. 1, 9 and 12-14. The head end cross strut 132, which has a circular cross section, is rotatably received in a slightly-oversized opening in the mounting flange 76 extending upwardly and rearwardly from the head end lift assembly 72. The side struts 136, 138 of the back section 100 extend rearwardly (as shown in FIG. 17) and pivotally couple to the side struts 216, 218 of the seat section 102 extending forwardly (as shown in FIG. 20) so that the back section 100 can articulate relative to the seat section 102 about a third transverse pivot axis 114.

In alternative embodiments, a pair of transversely-spaced longitudinally-extending flanges extend rearwardly from the foot end cross strut 134 of the back section 100 and pivotally couple to respective transversely-spaced longitudinally-extending flanges extending forwardly from the head end cross strut 202 of the seat section 102 so that the back section 100 can pivot relative to the seat section 102 about the third transverse pivot axis 114. An example of a pivotal connection between the back and seat sections 100, 102 of this type is shown and described in U.S. Pat. No. 6,076,208, which issued Jun. 20, 2000 and which is hereby incorporated by reference herein.

As shown in FIG. 18, the seat section 102 comprises a generally V-shaped central portion 150 including a first portion 152 near the back section 100 and a second portion 154 near the foot section 104 that narrows toward the foot end 34. The first portion 152 of the seat section 102 has a first transverse width 156, and the second portion 154 of the seat section 102 has a second transverse width 158 that is smaller than the first transverse width 156 such that a pair of cut-out areas 166, 168 are defined alongside the opposite sides 36, 38 of the second portion 154. A generally-triangular countertraction side portion 176, 178 is removably received in each cut-out area 166, 168 of the seat section 102. The countertraction side portions 176, 178 are detachably coupled to central portion 150 with suitable couplers, such as, for example, pins, sockets, latches, tabs, hooks, and the like.

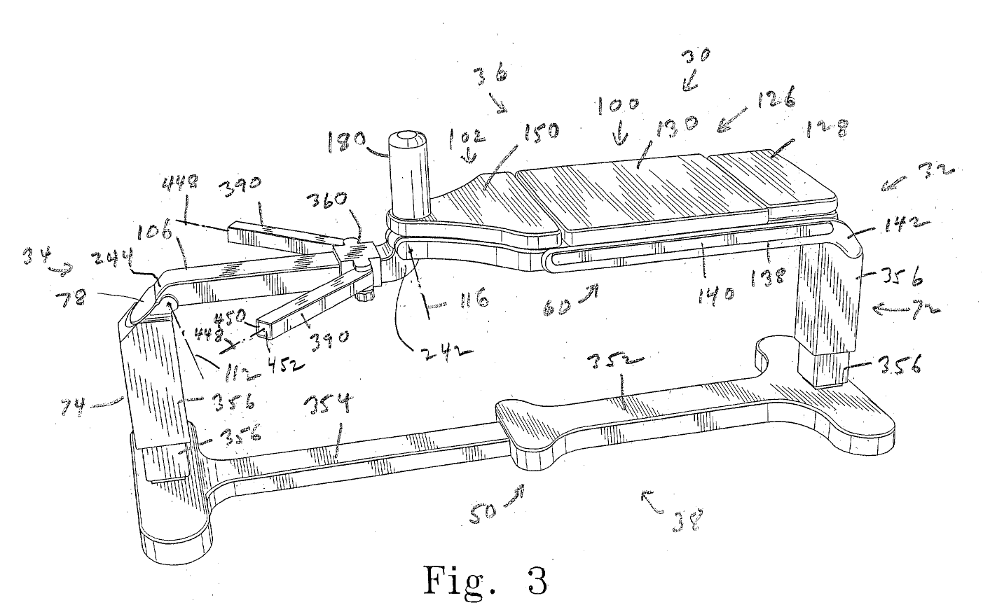

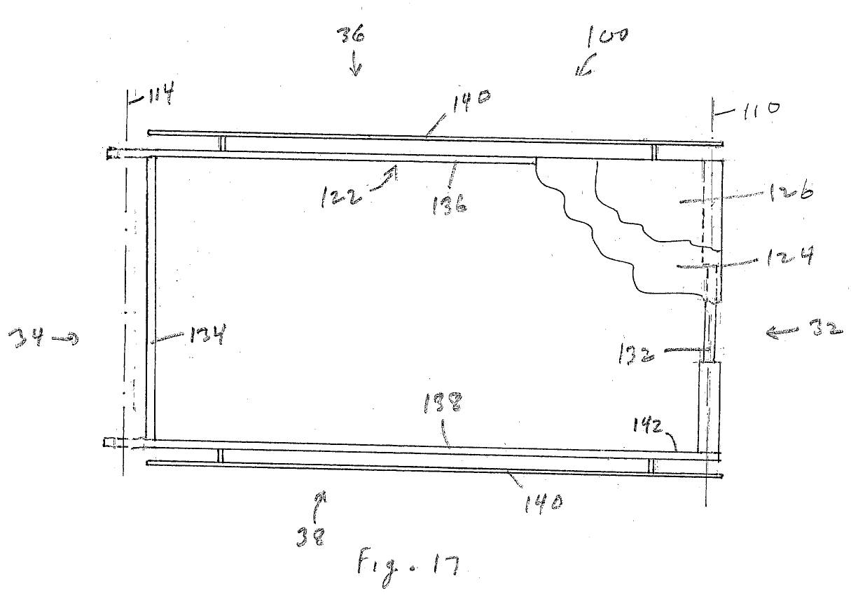

A vertically-extending countertraction post 180 is configured to be removably coupled to the seat section 102 as shown in FIGS. 3, 4 and 6-8. The countertraction post 180 includes a rigid vertical central shaft and a padding surrounding the middle and upper regions of the shaft. A lower region of the shaft extends downwardly from the padding, and is received in a vertically-extending socket 182 (shown in FIGS. 1 and 18) formed in the central portion 150 of seat section 102 near the foot section 104. A manual adjuster 184 is provided that tightens to secure the countertraction post 180 to the vertically-extending socket 182, and that loosens to release the countertraction post 180 from the vertically-extending socket 182 so that the countertraction post can be removed and stowed for later use. As shown in FIG. 19, the manual adjuster 184 comprises a knob 186 and a threaded shaft 188 extending from the knob 186 along a longitudinal axis 190. The knob 186 rotates about the longitudinal axis 190 in one direction, such as clockwise, to secure the connection between the post 180 and the socket 182, and the knob 186 rotates about the longitudinal axis 190 in an opposite direction, such as counterclockwise, to loosen the connection between the post 180 and the socket 182. An alternative configuration of the countertraction post is shown in FIG. 9. As shown therein, a laterally-extending countertraction post 183 is disposed between a patient's legs and engages the patient's pelvic region.

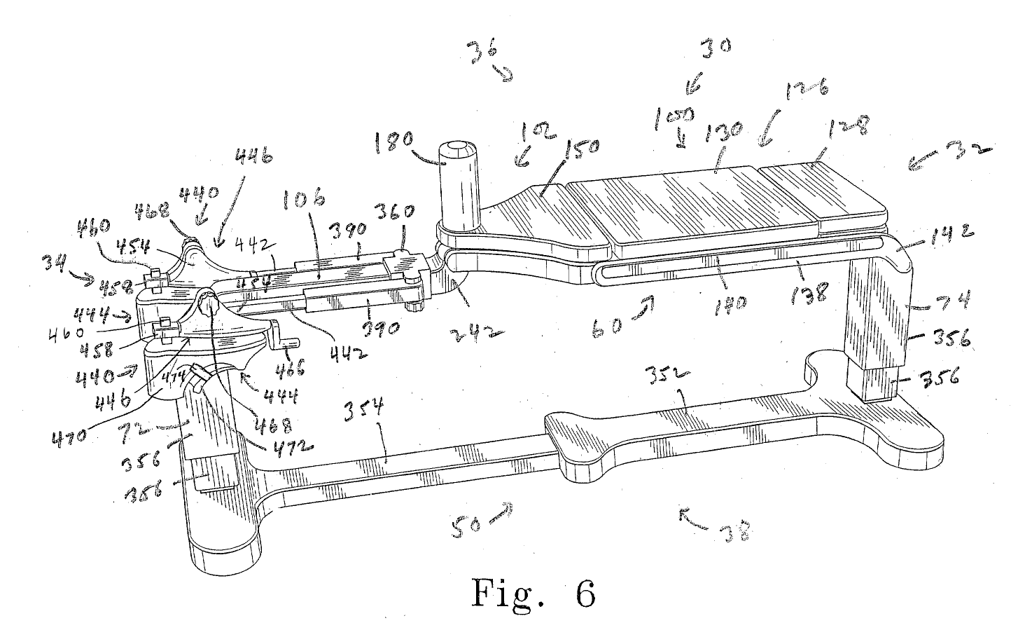

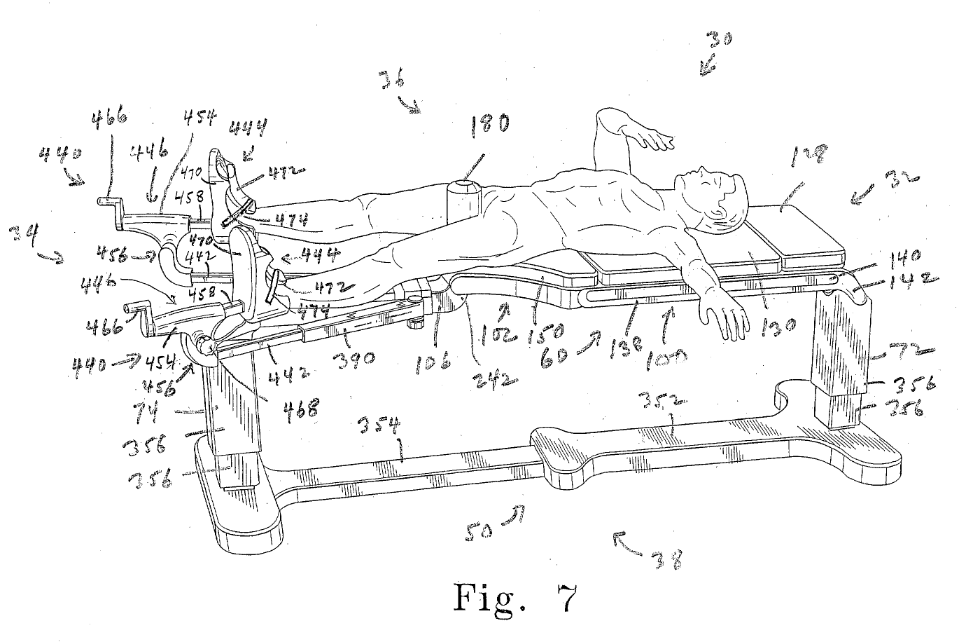

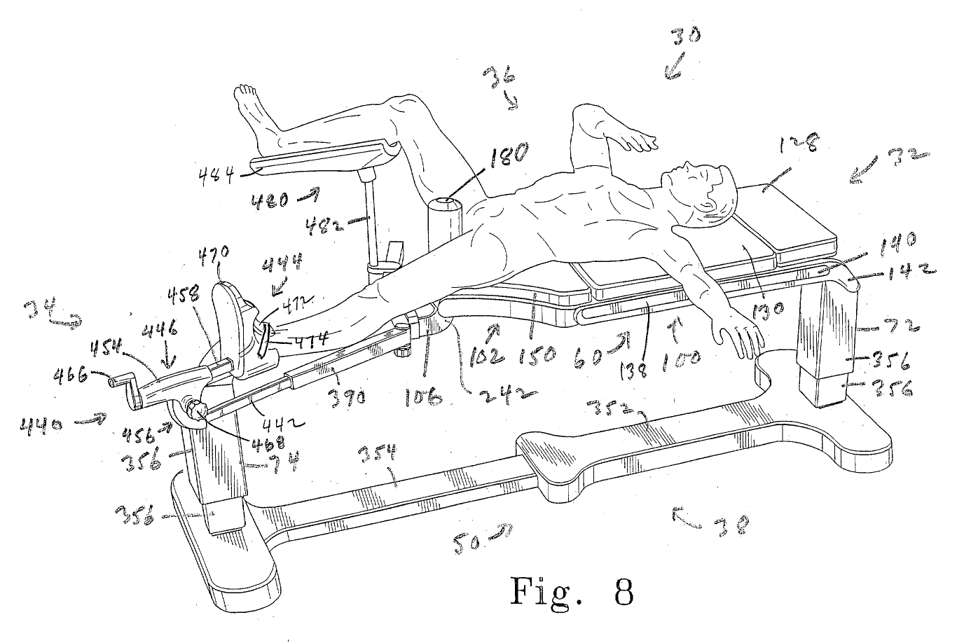

The countertraction side portions 176, 178 of the seat section 102 are detached from the central portion 150 of the seat section 102 and the countertraction post 180 is attached to the seat section 102 for applying bilateral hip traction to a patient as shown in FIG. 7, or for applying unilateral hip traction to the patient as shown in FIG. 8. Likewise, the countertraction side portions 176, 178 of the seat section 102 are detached from the central portion 150 of the seat section 102 and the laterally-extending countertraction post 183 is attached to the seat section 102 for performing a lateral intramedullary nailing procedure on the patient as shown in FIG. 9. For general surgical procedures, on the other hand, the countertraction post 180, 183 is removed from the seat section 102 and the countertraction side portions 176, 178 are reattached to the central portion 150 of the seat section 102 as shown in FIGS. 1 and 2. For purposes of this disclosure, general surgical procedures means any type of surgical procedures not classified as orthopedic surgical procedures.

As shown in FIG. 20, the generally V-shaped central portion 150 of the seat section 102 comprises a generally V-shaped frame 192 and a generally V-shaped central panel 194 attached to the frame 192. The generally V-shaped central panel 194 includes a substantially planar top surface that supports a cushion 196. The generally V-shaped frame 192 of the seat section 102 comprises a cross strut 204 near the foot section 104, first and second side struts 206, 208 that extend generally forwardly and outwardly from the foot end cross strut 204, third and fourth side struts 216, 218 that extend generally longitudinally and forwardly from the respective ends of the first and second side struts 206, 208 toward the back section 100 and a cross strut 202 near the back section 100. In the illustrated embodiment, the head end cross strut 202 and the side struts 206, 208, 216, 218 each have a generally rectangular cross section. The foot end cross strut 204, however, has a circular cross section. The guide rail 106 includes a portion 242 near the seat section 102 that extends upwardly, and couples to the foot end cross strut 204 for pivotal movement about a fourth transverse pivot axis 116 as shown in FIGS. 3, 4 and 12-14. The foot end cross strut 204 is rotatably received in a slightly-oversized opening in the upwardly-extending portion 242 of the guide rail 106.

Likewise, each generally triangular side portion 176, 178 of the seat section 102 comprises a generally triangular side frame 222 and a generally triangular side panel 224 attached to the side frame 222 as shown in FIG. 1. The generally triangular side panel 224 includes a substantially planar top surface that supports a cushion 226. The generally triangular side frame 222 on the first side 36 of the seat section 102 comprises a cross strut 234 near the foot section 104, an outboard side strut 236 that extends generally longitudinally and forwardly from the outer end of the foot end cross strut 234 and an inboard side strut 238 that extends generally outwardly from the inner end of the foot end cross strut 234. The generally triangular side frame 222 on the second side 38 of the seat section 102 comprises a cross strut 234 near the foot section 104, an outboard side strut 238 that extends generally longitudinally and forwardly from the outer end of the foot end cross strut 234 and an inboard side strut 236 that extends generally outwardly from the inner end of the foot end cross strut 234. The outboard and inboard side struts 236, 238 are joined together at the apex of the generally triangular side frame 222 of the seat section 102. In the illustrated embodiment, the foot end cross strut 234 and the side struts 236, 238 each have a generally rectangular cross section.

An accessory rail 240 is coupled to each outboard side strut 236, 238 by a pair of spacers that position the accessory rails 240 in spaced-apart relation with the respective side struts 236, 238. In the illustrated embodiment, the foot end cross strut 234, the side struts 236, 238 and the accessory rails 240 each have a generally rectangular cross section. Each of the cushions or mattress pads 196, 226 of the generally V-shaped central portion 150 and generally triangular side portions 176, 178 of the seat section 102 have the same general shape as the associated panels 194, 224, although, in some embodiments, the cushions or mattress pads 196, 226 overhang the edges of the associated panels 194, 224 by some amount.

As previously indicated, the side struts 216, 218 of the seat section 102 extend forwardly (as shown in FIG. 20) and pivotally couple to the rearwardly-extending side struts 136, 138 of the back section 100 (as shown in FIG. 17) so that the back section 100 can articulate relative to the seat section 102 about the third transverse pivot axis 114 as shown in FIGS. 12-14. The upwardly-extending portion 242 of the guide rail 106 near the seat section 102 couples to the foot end cross strut 204 of the seat section 102 for pivotal movement about the fourth transverse pivot axis 116 as shown in FIGS. 3, 4 and 12-14. The guide rail 106 includes a portion 244 near the foot end 34 that extends downwardly and rearwardly, and couples to a mounting flange 78 that extends upwardly and forwardly from the foot end lift assembly 74 for pivotal movement about the second transverse pivot axis 112 as shown in FIGS. 9 and 12-14. The portion 244 of the guide rail 106 has a circular cross section, and is rotatably received in a slightly-oversized opening in the mounting flange 78 extending upwardly and forwardly from the foot end lift assembly 74.

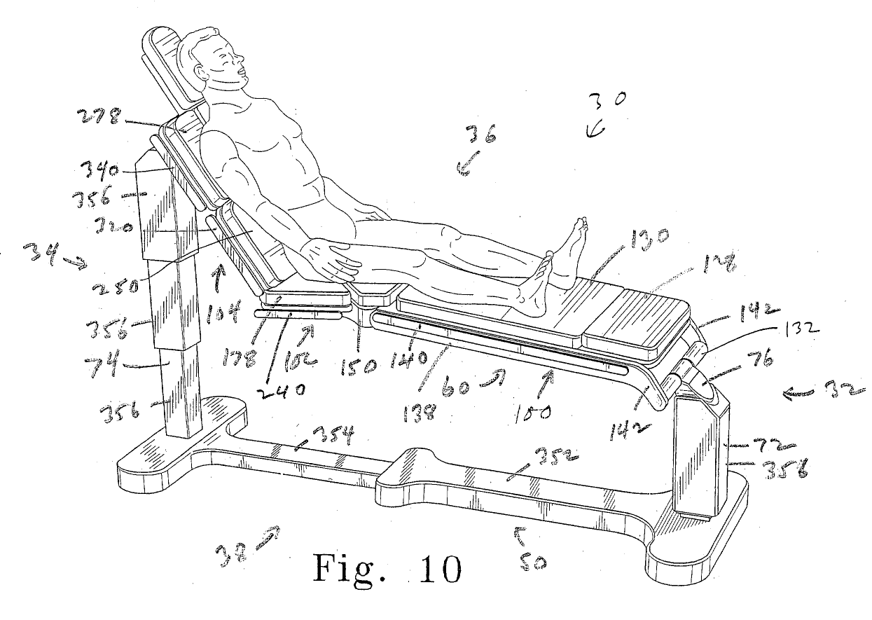

As shown in FIG. 21, the foot section 104 includes a generally T-shaped central portion 250 coupled to the guide rail 106. The central portion 250 includes a first portion 252 near the seat section 102 and a second portion 254 away from the seat section 102 near the foot end 34. The first portion 252 of the T-shaped central portion 250 has a first transverse width 256, and the second portion 254 of the T-shaped central portion 250 has a second transverse width 258 that is smaller than the first transverse width 256 such that a pair of cut-out areas 266, 268 are defined alongside the opposite sides 36, 38 of the second portion 254 near the foot end 34. A generally rectangular side portion 276, 278 is received in each cut-out area 266, 268 of the foot section 104 near the foot end 34 for movement between a first position where the side portion 276, 278 is coplanar with the foot section 104 and a second position away from the first position. The foot section 104 supports a patient's upper body, and at least one side portion 276, 278 is moved to the second out-of-the-way position to expose a posterior portion of the patient's shoulder during shoulder surgery as shown in FIGS. 10 and 11. The side portions 276, 278 of the foot section 104 near the foot end 34 are also sometimes referred to herein as shoulder pads. A narrow head attachment 280 is coupled to the foot section 104 near the foot end 34 to support the patient's head.

As previously indicated, the central and side portions 250, 276, 278 of the foot section 104 are detachably coupled to guide rail 106 with suitable couplers, such as, for example, pins, sockets, latches, tabs, hooks, and the like. The central and side portions 250, 276, 278 of the foot section 104, the countertraction side portions 176, 178 of the seat section 102 are all removed from the deck 60 and the countertraction post 180 is attached to the seat section 102 prior to applying bilateral or unilateral hip traction to a patient supported on the deck 60 as shown in FIGS. 7 and 8 respectively, and prior to performing a lateral intramedullary nailing procedure as shown in FIG. 9.

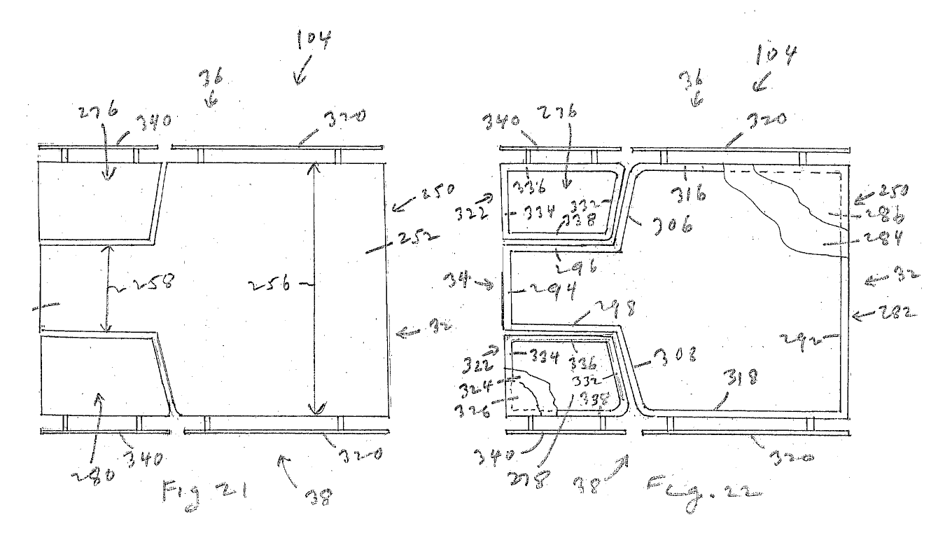

As shown in FIG. 22, the generally T-shaped central portion 250 of the foot section 104 comprises a generally T-shaped frame 282 and a generally T-shaped central panel 284 attached to the frame 282. The generally T-shaped central panel 284 includes a substantially planar top surface that supports a cushion 286. The generally T-shaped frame 282 of the foot section 104 comprises a cross strut 294 near the foot end 34, first and second side struts 296, 298 that extend generally longitudinally and forwardly from the respective ends of the foot end cross strut 294, third and fourth side struts 306, 308 that extend generally outwardly from the respective ends of the first and second side struts 296, 298, fifth and sixth side struts 316, 318 that extend generally longitudinally and forwardly from the respective ends of the third and fourth side struts 306, 308 and a cross strut 292 near the seat section 102. An accessory rail 320 is coupled to each of the fifth and sixth side struts 316, 318 of the generally T-shaped frame 282 of the foot section 104 by a pair of spacers that position the accessory rails 320 in spaced-apart relation with the respective side struts 316, 318. In the illustrated embodiment, the cross struts 292, 294, the side struts 296, 298, 306, 308, 316, 318 and the accessory rails 320 each have a generally rectangular cross section.

Likewise, each of the generally rectangular side portions 276, 278 of the foot section 104 comprises a generally rectangular side frame 322 and a generally rectangular side panel 324 attached to the frame 322. The generally rectangular side panel 324 includes a substantially planar top surface that supports a cushion 326. The generally rectangular side frame 322 on the first side 36 of the foot section 104 comprises a cross strut 334 near the foot end 34, an outboard side strut 336 that extends longitudinally and forwardly from outer end of the foot end cross strut 334, an inboard side strut 338 that extends longitudinally and forwardly from inner end of the foot end cross strut 334 and a cross strut 332 near the head end 32 joining the respective ends of the outboard and inboard side struts 336, 338. The generally rectangular side frame 322 on the second side 38 of the foot section 104 comprises a cross strut 334 near the foot end 34, an outboard side strut 338 that extends longitudinally and forwardly from outer end of the foot end cross strut 334, an inboard side strut 336 that extends longitudinally and forwardly from inner end of the foot end cross strut 334 and a cross strut 332 near the head end 32 joining the respective ends of the outboard and inboard side struts 336, 338.

An accessory rail 340 is coupled to each outboard side strut 336, 338 of the generally rectangular side frame 322 of the foot section 104 by a pair of spacers that position the accessory rails 340 in spaced-apart relation with the respective side struts 336, 338. Each of the cushions or mattress pads 286, 326 of the generally T-shaped central portion 250 and generally rectangular side portions 276, 278 of the foot section 104 have the same general shape as the associated panels 284, 324, although, in some embodiments, the cushions or mattress pads 286, 326 overhang the edges of the associated panels 284, 324 by some amount. In the illustrated embodiment, the cross struts 332, 334, the side struts 336, 338 and the accessory rails 340 each have a generally rectangular cross section.

As shown in FIG. 1, the base 50 includes a head end telescopic segment 352 coupled to the head end lift assembly 72 and a foot end telescopic segment 354 coupled to the foot end lift assembly 74. The head end telescopic segment 352 is stationary, and the foot end telescopic segment 354 is movable relative to the head end telescopic segment 352. As shown in FIGS. 12-15, the base 50 includes a plurality of floor-engaging locks 353 coupled to the stationary telescopic segment 352 and a plurality of floor-engaging rollers 355 coupled to the movable telescopic segment 354.

The head end and foot end telescopic segments 352, 354 of the base 50 shield from view the first drive mechanism 80 which is operable to extend and retract the base 50 along the longitudinal axis 40. Each lift assembly 72, 74 includes a number of telescopic segments 356 that shield from view the second and third drive mechanisms 82, 84 which are operable to raise and lower the deck 60. As previously indicated, the second and third drive mechanisms 82, 84 are also operable to tilt the deck 60 about a transverse axis to a Trendelenburg position (not shown) or to a reverse Trendelenburg position shown in FIG. 13. The articulating deck 60 shields from view a fourth drive mechanism 86 that is operable to articulate the back and foot sections 100, 104 relative to the seat section 102 as shown in FIG. 14. In addition, the lift assemblies 72, 74 shield from view fifth and sixth drive mechanisms 88, 90 that are operable to tilt the deck 60 side-to-side about the longitudinal axis 40 as shown in FIG. 15. A controller 92 is coupled to the various drive mechanisms 80-90 as shown in FIG. 16 to synchronize the extension and retraction of the base 50 with the articulation of the deck 60 and the extension and retraction of the two lift assemblies 72, 74. A user input device 94, such as a hand-held pendant or controller, is used to command the operation of the various drive mechanisms 80-90.

In some embodiments, the drive mechanisms 80-90 include hydraulic actuators such as the ones shown and disclosed, for example, in U.S. patent application Ser. Nos. 10/056,552, 10/056,916 and 10/056,959, all of which were filed Jan. 25, 2002, assigned to the same assignee as the present disclosure, and which are hereby incorporated by reference herein. In embodiments of the table 30 having hydraulic actuators, one or more reservoirs of hydraulic fluid, pumps, manifolds, valves, and hydraulic lines are housed within the telescopic segments 352-356 of the base 50 and the lift assemblies 72, 74 and the articulating sections 100-104 of the deck 60 in any suitable arrangement as is well-known in the art. Examples of a suitable user input device that may be included in the surgical table 30 are shown and described in U.S. Pat. No. 6,351,678, which issued Feb. 26, 2002 and which is hereby incorporated by reference herein.

It will be appreciated that various mechanical and electromechanical actuators and drivers may be used to raise and lower the deck 60, to tilt the deck 60 about the longitudinal and transverse axes 40, 42, and to articulate the back and foot sections 100, 104 of the deck 60 relative to the seat section 102. It is well known in the art that electric, hydraulic, and pneumatic actuators in combination with various types of transmission elements including lead screw drives and various types of mechanical linkages may be used to create relative movement of portions of patient-support devices. As a result, terms such as “drive mechanism,” “drive,” and the like, are intended to cover all types of mechanical, electromechanical, hydraulic, and pneumatic mechanisms, including manual cranking mechanisms of all types, and including combinations thereof such as hydraulic cylinders in combination with electromechanical pumps for pressurizing fluid received by the hydraulic cylinders.

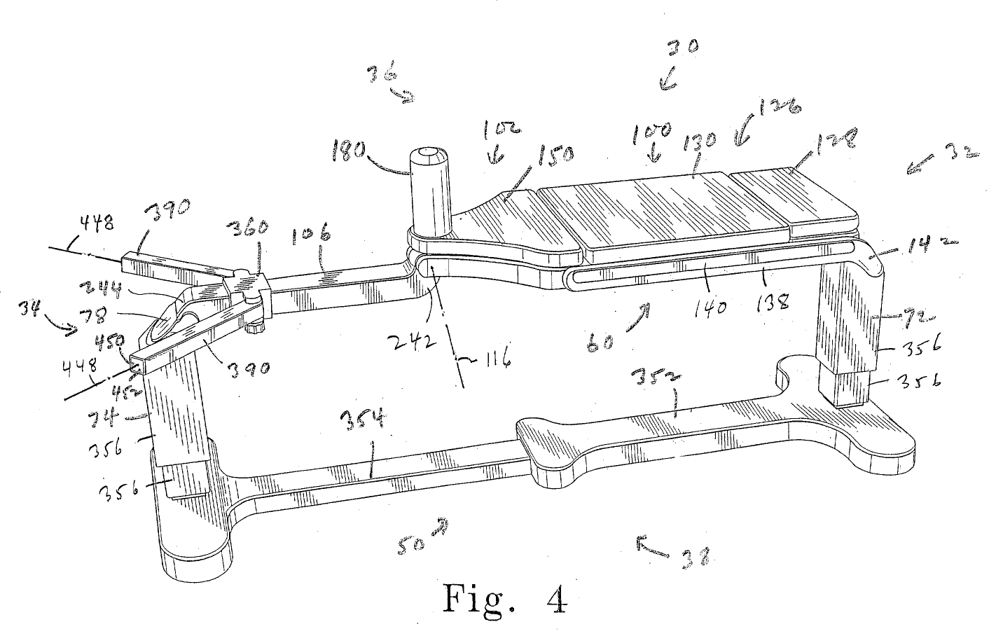

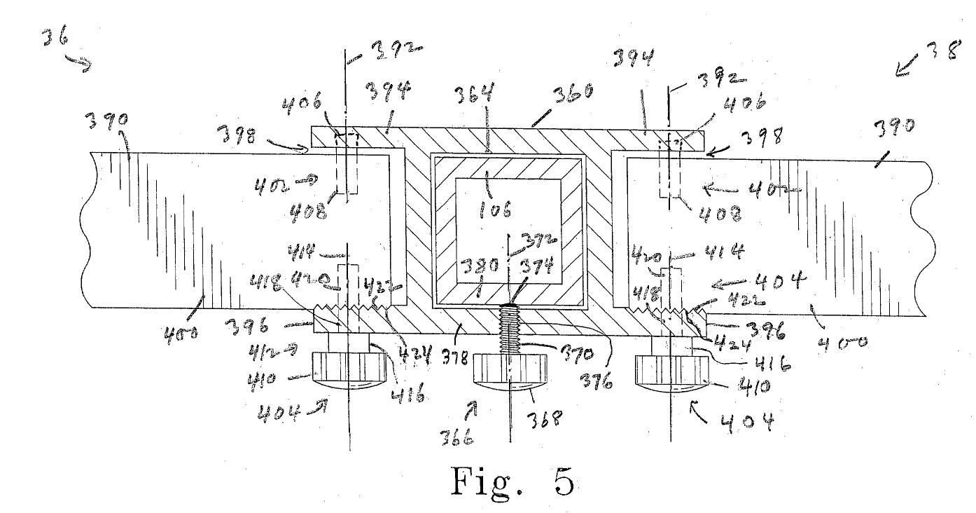

Referring now to FIGS. 3-9, a mount 360 for a pair of traction boot assemblies 440 is coupled to the longitudinally-extending centrally-located guide rail 106. The mount 360 is movable longitudinally along the guide rail 106 between a position close to the seat section 102 as shown in FIG. 3 and a position close to the foot end 34 as shown in FIG. 4. As shown in FIG. 5, the guide rail 106 is in the form of a square-shaped tube, and the mount 360 has a square-shaped slightly-oversized opening 364 for slidably receiving the square-shaped guide rail 106. The mount 360 includes a manual adjuster 366 that is movable to loosen the connection between the mount 360 and the guide rail 106 to permit longitudinal translation of the mount 360 relative to guide rail 106, and that is movable to tighten the connection between the mount 360 and the guide rail 106 to lock the mount 360 in the desired position relative to guide rail 106.

In the illustrative embodiment, the manual adjuster 366 comprises a knob 368 and a threaded shaft 370 extending from the knob 368 along a longitudinal axis 372 as shown in FIG. 5. The threaded shaft 370 is screwed into a threaded opening 376 in a lower wall 378 of the mount 360. The knob 368 rotates about the longitudinal axis 372 in one direction, such as clockwise direction, to tighten the connection between the mount 360 and the guide rail 106, and the knob 372 rotates about the longitudinal axis 372 in an opposite direction, such as counterclockwise direction, to loosen the connection between the mount 360 and the guide rail 106. Specifically, the threaded shaft 370 has a tip 374 that is pressed against the lower wall 380 of the guide rail 106 when the knob 368 is turned clockwise to secure the mount 360 to the guide rail 106, and that is separated from the lower wall 380 of the guide rail 106 when the knob 368 is turned anticlockwise to allow longitudinal translation of the mount 360 relative to the guide rail 106. In some embodiments, the manual adjuster 366, as well as any other manual adjusters disclosed herein, are provided with a torque limiting mechanism such as the type shown and disclosed, for example, in U.S. patent application Ser. Nos. 10/056,552 and 10/056,959, which are already incorporated by reference herein.

As shown in FIGS. 3-5, a pair of elongated traction bars 390 are coupled to the mount 360 on the opposite sides 36, 38 of the mount 360 for indexing movement about respective pivot axes 392. Each side 36, 38 of the mount 360 includes top and bottom outwardly-extending mounting flanges 394, 396 that form a recess 398 in which the pivotally-mounted end 400 of an associated traction bar 390 is received for rotation about a top pin 402 and a bottom pin 404. Each top pin 402 has a threaded portion 406 and a non-threaded portion 408. The threaded portion 406 is screwed into a threaded opening in the top flange 394 of the mount 360, and the non-threaded portion 408 is rotatably received in a slightly-oversized opening in the top side of the traction bar 390.

Each bottom pin 404 serves as a manual adjuster for an associated traction bar 390. The bottom pin 404 is rotated in one direction, such as clockwise, to lock the traction arm 390 to the mount 360, and the bottom pin 404 is rotated in an opposite direction, such as anticlockwise, to free the traction arm 390 to index relative to the mount 360. Each bottom pin 404 includes a knob 410 and a shaft 412 extending from the knob 410 along a longitudinal axis 414. Each shaft 412 has a non-threaded spacer portion 416, a non-threaded intermediate portion 418 and a threaded end portion 420. The spacer portion 416 serves to distance the knob 410 from the underside of the bottom flange 396 of the mount 360 to permit a user to grasp the knob 410 for rotation. The intermediate portion 418 is rotatably received in a slightly-oversized opening in the bottom flange 396 of the mount 360. The threaded end portion 420 is screwed into a threaded opening in the bottom side of the traction bar 390. The knob 410 rotates about the longitudinal axis 414 in a clockwise direction to lock the traction bar 390 relative to the mount 360, and the knob 410 rotates about the longitudinal axis 414 in a counterclockwise direction to free the traction bar 396 to rotate. Specifically, the traction bar 390 is pulled against the bottom flange 396 of the mount 360 to lock the traction bar 390 in place when the knob 410 is turned clockwise, and the traction bar 390 is separated from the bottom flange 396 of the mount 360 to free the traction bar 390 to rotate relative to the mount 360 when the knob 410 is turned anticlockwise.

In some embodiments, as shown in FIG. 5, the downwardly-facing surfaces of the traction bars 390 have serrations or teeth 422, and the upwardly-facing surfaces of the bottom flanges 396 of the mount 360 have serrations or teeth 424 at the common interface. Tightening of the knob 410 causes the teeth 422 on the downwardly-facing surfaces of the associated traction bar 390 to press against and intermesh with the teeth 424 on the upwardly-facing surfaces of the associated bottom flange 396 of the mount 360 to prevent the traction bar 390 from rotating relative to the mount 360. Loosening of the knob 410, on the other hand, allows the respective teeth 422, 424 of the associated traction bar 390 and the mounting flange 396 to separate to permit the traction bar 390 to rotate relative to the mount 360. Alternative mechanisms for releasably locking the traction bars 390 relative to the mount 360 are contemplated by this disclosure. For example, various types of manually operated clutch and release mechanisms, such as lever operated clutches and push button operated clutches like those shown and described in U.S. patent application Ser. Nos. 10/056,552 and 10/056,959 may be used for locking the traction bars 390 in lieu of the manual adjusters 404 shown and described herein.

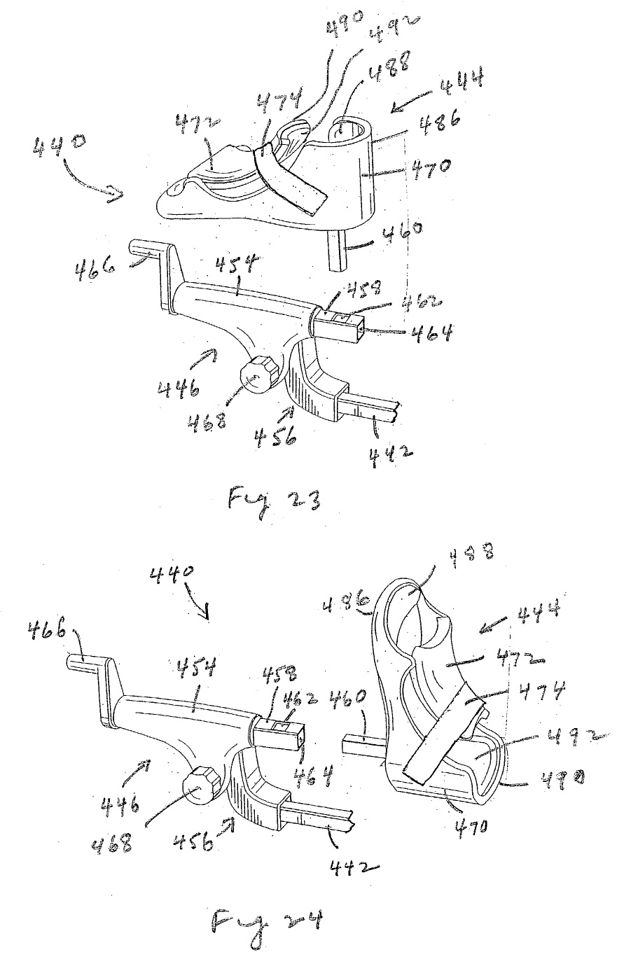

As shown in FIGS. 6-9, the traction boot assemblies 440 are coupled to the respective traction bars 390. As shown in FIGS. 23 and 24, each traction boot assembly 440 includes an elongated rod 442 that is movable along a longitudinal dimension 448 (FIGS. 3 and 4) of the associated traction bar 390, a traction boot 444 configured to couple to a patient's foot, and an adjustment assembly 446 coupled to the traction boot 444 and coupled to the elongated rod 442. The adjustment assembly 446 is configured to permit rotational and translational adjustment of the traction boot 444 relative to the elongated rod 442. As shown in FIGS. 3 and 4, each traction bar 390 is tubular in shape, and defines an elongated passageway 450 along the long axis 448 thereof and terminating in an opening 452. The elongated rod 442 is inserted through the opening 452 into the passageway 450 when the traction boot assembly 440 is coupled to the associated traction bar 390. The longitudinal dimension 448 of the traction bar 390 is also sometimes referred to herein as the long axis of the traction bar 390.

As shown in FIGS. 23 and 24, the adjustment assembly 446 comprises a housing 454 to which the traction boot 444 couples and a joint 456 that couples the housing 454 to the elongated rod 442. A tube 458 extends from the housing 454, and a post 460 extends from the traction boot 444. The tube 458 includes a first opening 462 that receives the post 460 when the traction boot 444 is coupled to the tube 458 in a first orientation for storage as shown in FIG. 23. In the illustrative embodiment, the tube 458 and the post 460 both have a square-shaped cross section, and the first opening extends through the top and bottom walls of the square-shaped tube 458. The post 460 is perpendicular to the tube 458 when the traction boot 444 is coupled to the tube 458 in the first orientation. After inserting the post 460 into the first opening 462 as shown in FIG. 23, the housing 454 of the adjustment assembly 446 carrying the traction boot 444 is pivoted about a horizontal axis to position the traction boot 444 beneath the top surface of the deck 60 for storage as shown in FIG. 6.

The tube 458 includes a second opening 464 that receives the post 460 when the traction boot 444 is coupled to the tube 458 in a second orientation for applying bilateral or unilateral traction to a patient's foot as shown in FIGS. 7 and 8, or a third orientation for performing a lateral intramedullary nailing procedure on the patient as shown in FIG. 9. The post 460 is substantially coaxial with the tube 458 when the traction boot 444 is coupled to the tube 458 in the second orientation as shown in FIG. 24 and in the third orientation. In the illustrative embodiment, the interior region of the tube 458 has a wall of square-shaped cross section for receiving the square-shaped post 460. In some illustrative embodiments, the traction boot 444 includes a sole portion configured to engage a bottom of a patient's foot, and the post 460 extends from the sole portion. For lateral intramedullary nailing procedure, an extra bar 476 and a clamp 478 are used to support the traction boot 444 associated with a patient's right foot in an elevated position relative to the traction bar 390 as shown in FIG. 9.

In the illustrative embodiments, a hand crank 466 is coupled to the housing 454 and coupled to the tube 458 to translate the traction boot 444 relative to the elongated rod 442 as shown in FIGS. 7-9. In the illustrative embodiments, the adjustment assembly 446 includes a manual adjuster 468, such as the manual adjuster 184 shown in FIG. 19, that tightens to lock the joint 456 to prevent rotation of the housing 454 and the traction boot 444 relative to the elongated rod 442, and that loosens to unlock the joint 456 to allow rotation of the housing 454 and the traction boot 444 relative to the elongated rod 442.

As shown in FIGS. 23 and 24, the traction boot 444 comprises a first portion 470 configured to engage a bottom of a patient's foot, a second portion 472 coupled to the first portion 470 for movement between a first position engaging a top of the patient's foot and a second position away from the first position, and a strap 474 that engages the first and second portions 470, 472 to lock the second portion 472 in the first position. The strap 474 extends across a top surface of the second portion 472 between a first side of the first portion 470 and a second side of the first portion 470 when the second portion 472 is locked in the first position. The first portion 470 is configured also to engage a back of a patient's heel. The first portion 470 comprises a shell 486 that is substantially rigid and a cushioning material 488 coupled to at least part of the shell 486. The second portion 472 also comprises a shell 490 that is substantially rigid and a cushioning material 492 coupled to the at least part of the shell 490. The cushioning material 492 engages the top of the patient's foot when the second portion 472 is in the first position.

As shown in FIG. 8, a leg support 480 having a mounting portion 482 is coupled to the traction bar 390 associated with the patient's right leg. The leg support 480 includes a calf support portion 484 for supporting a patient's calf. The mounting portion 482 is positioned to support the calf portion of a patient's right leg in an elevated position. The leg support 480 includes a manual adjuster, such as the manual adjuster 184 shown in FIG. 19, that tightens to secure the mounting portion 482 of the leg support 480 to the traction bar 390, and that loosens to release the leg support 480. Although the illustrated leg support 480 is coupled to the traction bar 390 associated with a patient's right leg as shown in FIG. 8, the leg support 480 may very well be coupled to the traction bar 390 associated with a patient's left leg. A traction boot assembly of this type is shown and described in detail in U.S. patent application Ser. No. ______ (Attorney Docket No. 7175-69326), entitled “ORTHOPEDIC TABLE APPARATUS”, which is filed on the same day as this application, which is assigned to the same assignee as this patent application, and which is hereby incorporated in its entirety by reference herein.

Although the inventions have been described herein in detail with reference to certain preferred embodiments, additional variations and modifications exist within the scope and spirit of the inventions as described and defined in the following claims.

What is claimed is

1. A patient support apparatus having a longitudinal axis, the apparatus comprising:
first and second lift assemblies, each lift assembly being extendible in a vertical direction,
a longitudinally-extending base supported on a floor and having first and second ends coupled to the first and second lift assemblies respectively, the base being extendible along the longitudinal axis, and
a longitudinally-extending deck supported above the base and having first and second ends coupled to the first and second lift assemblies respectively, the deck being articulatable to support a patient in selected positions.

2. The apparatus of claim 1, wherein the base comprises first and second telescopic portions coupled to the first and second lift assemblies respectively.

3. The apparatus of claim 2, wherein the first telescopic portion of the base is stationary and the second telescopic portion of the base is movable relative to the first telescopic portion.

4. The apparatus of claim 3, wherein the base includes at least one floor-engaging lock coupled to the first telescopic portion and at least one floor-engaging roller coupled to the second telescopic portion.

5. The apparatus of claim 3, wherein the base includes a drive having a first end coupled to the first telescopic portion and a second end coupled to the second telescopic portion for causing longitudinal movement thereof.

6. The apparatus of claim 1, wherein each lift assembly comprises first and second telescopic portions coupled to the base and the articulating deck respectively.

7. The apparatus of claim 6, wherein the first telescopic portion of each lift assembly is fixed to the base and the second telescopic portion of each lift assembly is coupled to the articulating deck and movable relative to the first telescopic portion.

8. The apparatus of claim 7, wherein each lift assembly includes a drive having a first end coupled to the first telescopic portion of the lift assembly and a second end coupled to the second telescopic portion of the lift assembly.

9. The apparatus of claim 1, comprising a first drive coupled to the extendible base for causing extension and retraction thereof, a second drive coupled to the articulating deck for causing articulation thereof, and a controller coupled to the first and second drives to synchronize extension and retraction of the base with the articulation of the deck.

10. The apparatus of claim 9, comprising third and fourth drives coupled respectively to the two lift assemblies for causing extension and retraction thereof, wherein the controller is additionally coupled to the third and fourth drives to synchronize the extension and retraction of the base with the articulation of the deck and the extension and retraction of the two lift assemblies.

11. The apparatus of claim 1, wherein the articulating deck comprises first, second and third sections, wherein the first, second and third sections are longitudinally spaced apart and articulatable, and wherein each section includes laterally-spaced, longitudinally-extending opposite sides.

12. The apparatus of claim 1 1, wherein the first and second ends of the deck correspond respectively to a head end and a foot end thereof, wherein the deck comprises a back section, a seat section and a foot section, and wherein the back, seat and foot sections are longitudinally spaced apart with the back and foot sections articulatable relative to the seat section.

13. The apparatus of claim 12, wherein the back section is coupled to the first lift assembly for movement about a first transverse axis near the head end, and wherein the leg section is coupled to the second lift assembly for movement about a second transverse axis near the foot end.

14. The apparatus of claim 11, wherein the second section includes a central portion and first and second countertraction side portions on the opposite sides of the central portion near the third section.

15. The apparatus of claim 11, wherein the second section comprises a central portion including a first portion near the first section and a second portion away from the first section near the third section, the first portion having a first transverse width and the second portion having a second transverse width that is smaller than the first transverse width such that a pair of cut-out areas are defined alongside the opposite sides of the second portion near the third section, and wherein a countertraction side portion is received in each cut-out area of the second section.

16. The apparatus of claim 15, wherein the first and second countertraction side portions are removably coupled to the central portion.

17. The apparatus of claim 15, wherein the second section further includes a removable countertraction post.

18. The apparatus of claim 17, wherein the second section additionally includes a socket, and wherein the countertraction post is removably received in the socket.

19. The apparatus of claim 18, wherein the second section further includes a manual adjuster that tightens to secure the countertraction post to the socket, and that loosens to release the countertraction post from the socket.

20. The apparatus of claim 11, wherein the third section includes a guide rail.

21. The apparatus of claim 20, wherein the third section further includes a central portion coupled to the guide rail and first and second side portions on the opposite sides of the central portion near the foot end of the third section.

22. The apparatus of claim 20, wherein the third section further includes a central portion coupled to the guide rail, wherein the central portion includes a first portion near the second section and a second portion away from the second section near the foot end, the first portion having a first transverse width and the second portion having a second transverse width that is smaller than the first transverse width such that a pair of cut-out areas are defined alongside the opposite sides of the second portion near the foot end, and wherein a pad is received in each cut-out area of the third section for movement between a first position where the pad is coplanar with the third section and a second position away from the first position.

23. The apparatus of claim 21, wherein the central and side portions are removably coupled to the guide rail.

24. The apparatus of claim 21, wherein each side portion is movable between a first position where the side portion is coplanar with the central portion and a second position away from the first position where the side portion is moved out of the way.

25. The apparatus of claim 24, wherein the third section supports a patients upper body, and wherein at least one side portion is moved to the second out-of-the-way position during shoulder surgery.

26. The apparatus of claim 20, wherein the guide rail extends generally longitudinally and centrally relative to the deck.

27. The apparatus of claim 20, comprising a mount coupled to the guide rail and movable longitudinally along the guide rail, and at least one elongated traction bar moveably coupled to the mount for movement toward and away from the guide rail.

28. The apparatus of claim 27, wherein the at least one elongated traction bar is pivotably coupled to the mount on a first side thereof for movement about a pivot axis.

29. The apparatus of claim 27, comprising a first elongated traction bar coupled to the mount on a first side thereof for movement about a first pivot axis, and a second elongated traction bar coupled to the mount on a second side thereof for movement about a second pivot axis.

30. The apparatus of claim 29, further comprising first and second traction boot assemblies configured to couple to the first and second elongated traction bars, and movable along longitudinal dimensions of the respective traction bars.

31. The apparatus of claim 29, wherein the first and second pivot axes are vertical.

32. The apparatus of claim 27, comprising a first manual adjuster that tightens to prevent the mount from moving longitudinally relative to the guide rail, and a second manual adjuster that tightens to prevent the at least one traction bar from moving relative to the mount.

33. The apparatus of claim 27, further comprising a leg support having a mounting portion configured to couple to the at least one traction bar, the leg support being configured to support at least a portion of a patient's leg.

34. The apparatus of claim 33, wherein the leg support is configured to support the calf portion a patient's leg.

35. The apparatus of claim 33, wherein the leg support includes a manual adjuster that tightens to lock the mounting portion of the leg support to the traction bar and that loosens to release the mounting portion of the leg support from the traction bar.

36. The apparatus of claim 27, further comprising at least one traction boot assembly configured to couple to the at least one traction bar, and movable longitudinally along a longitudinal dimension of the traction bar.

37. The apparatus of claim 36, wherein each traction boot assembly comprises an elongated rod, and wherein each traction bar is formed to include an elongated passageway for receiving the rod for adjusting movement therein.

38. The apparatus of claim 37, wherein each elongated traction bar is tubular defining an interior region terminating in an opening, and wherein the elongated rod extends through the opening into the interior region of the traction bar when the at least one traction boot assembly is coupled to the at least one traction bar.

39. The apparatus of claim 36, wherein the at least one traction boot assembly includes a manual adjuster that tightens against the at least one traction bar to lock the at least one traction boot assembly in place relative to the at least one traction bar.

40. The apparatus of claim 36, wherein the at least one traction boot assembly includes a traction boot that is configured to couple to a patient's foot, and wherein the traction boot is movable relative to the at least one traction bar.

41. The apparatus of claim 40, wherein each traction boot includes a first portion configured to engage a bottom of a patient's foot, a second portion coupled to the first portion for movement between a first position engaging a top of the patient's foot and a second position away from the first position, and a lock that engages the first and second portions to lock the second portion in the first position.

42. The apparatus of claim 27, further comprising at least one traction boot assembly having an elongated rod that is movable along a longitudinal dimension of the at least one traction bar, a traction boot configured to couple to a patient's foot, and an adjustment assembly coupled to the traction boot and coupled to the rod, the adjustment assembly being configured to permit rotational and translational adjustment of the traction boot relative to the rod.

43. The apparatus of claim 42, wherein the adjustment assembly comprises a housing to which the traction boot couples and a joint that couples the housing to the rod.

44. The apparatus of claim 43, wherein the adjustment assembly comprises a hand crank coupled to the housing, the hand crank is rotatable about an axis relative to the housing, and rotation of the hand crank about the axis translates the traction boot relative to the rod.

45. The apparatus of claim 43, wherein the adjustment assembly comprises a manual adjuster that tightens to lock the joint to prevent rotation of the housing and traction boot relative to the rod and that loosens to unlock the joint to allow rotation of the housing and traction boot relative to the rod.

46. The apparatus of claim 43, wherein the traction boot assembly includes a post extending from the traction boot, the adjustment assembly includes a tube extending from the housing, the tube includes a first opening that receives the post when the traction boot is coupled to the tube in a first orientation, and the tube includes a second opening that receives the post when the traction boot is coupled to the tube in a second orientation.

47. The apparatus of claim 46, wherein the post is perpendicular to the tube when the traction boot is coupled to the tube in the first orientation and the post is substantially coaxial with the tube when the traction boot is coupled to the tube in the second orientation.

48. The apparatus of claim 42, wherein the traction boot comprises a first portion configured to engage a bottom of a patient's foot, a second portion coupled to the first portion for movement between a first position engaging a top of the patient's foot and a second position away from the first position, and a lock that engages the first and second portions to lock the second portion in the first position.

49. The apparatus of claim 48, wherein the lock comprises a strap that extends across a top surface of the second portion between a first side of the first portion and a second side of the first portion when the second portion is locked in the first position.

50. The apparatus of claim 48, wherein the first portion is configured also to engage a back of a patient's heel.

51. The apparatus of claim 50, wherein the first portion comprises a shell that is substantially rigid and a cushioning material coupled to at least part of the shell.

52. The apparatus of claim 48, wherein the second portion comprises a shell that is substantially rigid and a cushioning material coupled to the at least part of the shell.

53. The apparatus of claim 52, wherein the cushioning material engages the top of the patient's foot when the second portion is in the first position.

54. The apparatus of claim 42, wherein the traction boot assembly includes a post extending from the traction boot, the adjustment assembly includes a tube, the tube includes a first opening that receives the post when the traction boot is coupled to the tube in a first orientation, and the tube includes a second opening that receives the post when the traction boot is coupled to the tube in a second orientation.

55. The apparatus of claim 42, wherein the traction boot includes a sole portion configured to engage a bottom of a patient's foot and a post extending from the sole portion, the adjustment assembly includes a tube having a long axis, the tube having a first opening near one end, and the post being insertable through the first opening to couple the traction boot to the tube having the sole portion in a first orientation, the tube having an interior region extending along the long axis and terminating in a second opening at said one end, the post being insertable through the first opening into the interior region to couple the traction boot to the tube having the sole portion in a second orientation.

56. The apparatus of claim 55, wherein the post includes a square-shaped cross section, the interior region of tube includes a tube wall of square-shaped cross section for receiving the square-shaped post.

57. A patient support apparatus having head and foot ends and a longitudinal axis, the apparatus comprising:
a longitudinally-extending deck including a head section, a seat section and a foot section, the head, seat and foot sections being longitudinally spaced apart and articulatable,
the foot section including a first portion near the seat section and having a first transverse width, the foot section including a second portion away from the seat section and having a second transverse width that is smaller than the first transverse width such that a pair of cut-out areas are defined alongside the opposite sides of the second portion, and
a pad received in each cut-out area of the foot section for movement between a first position where the pad is coplanar with the foot section and a second position away from the first position.

58. The apparatus of claim 57, wherein the foot section supports a patient's upper body with the pads serving as shoulder pads, and wherein at least one pad is moved to the second position during shoulder surgery.

59. The apparatus of claim 58, comprising a longitudinally-extending base supported on a floor and extendible along the longitudinal axis.

60. The apparatus of claim 59, further comprising head end and foot end lift assemblies coupled to the extendible base and coupled to the articulating deck, each lift assembly being extendible in a vertical direction.

61. The apparatus of claim 60, wherein the head section is coupled to the head end lift assembly for movement about a first transverse axis near the head end, and the foot section is coupled to the foot end lift assembly for movement about a second transverse axis near the foot end.

62. A patient support apparatus having head and foot ends and a longitudinal axis, the apparatus comprising:
head end and foot end lift assemblies, each lift assembly being extendible in a vertical direction,
a longitudinally-extending base supported on a floor and having head and foot ends thereof coupled to the head and foot end lift assemblies respectively, the base being extendible along the longitudinal axis,
a longitudinally-extending deck including a head section, a seat section and a foot section, the head, seat and foot sections being longitudinally spaced apart and articulatable, the head section being coupled to the head end lift assembly, and the foot section being coupled to the foot end lift assembly,
the foot section including a first portion near the seat section and having a first transverse width, the foot section including a second portion away from the seat section and having a second transverse width that is smaller than the first transverse width such that a pair of cut-out areas are defined alongside the opposite sides of the second portion, and
a pad received in each cut-out area of the foot section for movement between a first position where the pad is coplanar with the foot section and a second position away from the first position,
the foot section supporting a patient's upper body with the pads serving as shoulder pads, and at least one pad being moved to the second out-of-the-way position during shoulder surgery.

63. The apparatus of claim 62, wherein the head section is coupled to the first lift assembly for movement about a first transverse axis near the head end, and the foot section is coupled to the second lift assembly for movement about a second transverse axis near the foot end,

64. A patient support apparatus having a longitudinal axis, the apparatus comprising:
a base,
a deck supported above the base, the deck including a guide rail,
a mount coupled to the guide rail and movable longitudinally along the guide rail,
a traction bar movably coupled to the mount for lateral movement, and
a traction boot assembly configured to couple to the traction bar and movable along a longitudinal dimension of the traction bar.

65. The apparatus of claim 64, wherein the deck additionally includes a back section, a seat section and a foot section coupled to the guide rail, wherein the back, seat and foot sections are longitudinally spaced apart with the back and foot sections articulatable relative to the seat section.

66. The apparatus of claim 64, wherein the guide rail extends generally longitudinally and centrally relative to the deck.

67. A patient support apparatus comprising:
a longitudinally-extending, upwardly-facing patient support having a head end, a foot end and longitudinally extending opposite sides, the patient support comprising a head section, a seat section and foot section, the head, seat and foot sections being articulatable to support a patient in selected positions,
a base extending longitudinally under the patient support, the base comprising a head end portion and a foot end portion configured for selective longitudinal movement,
a head end lift assembly disposed between the head section of the patient support and the head end portion of the base, and
a foot end lift assembly disposed between the foot section of the patient support and the foot end portion of the base.

68. The apparatus of claim 67, wherein the foot section includes a generally longitudinally-extending centrally-located guide rail, a mount coupled to the guide rail and movable longitudinally along the guide rail, a traction bar movably coupled to the mount for lateral movement, and a traction boot assembly configured to couple to the traction bar and movable along a longitudinal dimension of the traction bar.

69. A patient support apparatus having a longitudinal axis, the apparatus comprising:
first and second lift assemblies, each lift assembly being extendible in a vertical direction,
a longitudinally-extending base supported on a floor and having first and second ends coupled to the first and second lift assemblies respectively, the base being extendible along the longitudinal axis, and
a longitudinally-extending deck having first and second ends coupled to the first and second lift assemblies respectively.
